(19) United States
(12) Patent Application Publication
(10) Pub. No.: US 2015/0004474 A1
(43) Pub. Date: Jan. 1, 2015

(54) SECONDARY BATTERY

(71) Applicant: Samsung SDl Co., Ltd., Yongin-si (KR)

(72) Inventors: Seon-Hong Lee, Yongin-si (KR); Jee-Won Kang, Yongin-si (KR); Jong-Man Kim, Yongin-si (KR); Jee-Hoon Han, Yongin-si (KR); Young-Woong Kwon, Yongin-si (KR); Hee-Sung Choi, Yongin-si (KR); Byong-Gon Lee, Yongin-si (KR); Maeng-Eun Lee, Yongin-si (KR); Jake Kim, Yongin-si (KR)

(73) Assignee: Samsung SDl Co., Ltd., Yongin-si (KR)

(21) Appl. No.: 14/179,404

(22) Filed: Feb. 12, 2014

Related U.S. Application Data
(60) Provisional application No. 61/841,851, filed on Jul. 1, 2013.

(51) Int. Cl. H01M 10/44; H01M 10/058; H01M 10/0568; H01M 10/04; H01M 10/052

(52) U.S. Cl. CPC H01M 10/446; H01M 10/049; H01M 10/0436; H01M 10/052; H01M 10/0568; H01M 10/058; H01M 2220/30; H01M 4/366
USPC 429/163; 29/623.1

(57) ABSTRACT

A method of manufacturing a secondary battery is disclosed. In one aspect, a method of manufacturing a secondary battery includes assembling the secondary battery by receiving an electrode assembly including a first pole plate, a second pole plate and a separator between the first and second pole plates, along with an electrolyte, in a battery case. The method further includes precharging the secondary battery, leaving the secondary battery at room temperature and performing first charging and first discharging of the secondary battery.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference under 37 CFR 1.57. For example, this application claims priority to and the benefit of Provisional Patent Application No. 61/841,851 filed on Jul. 1, 2013 in the U.S Patent and Trademark Office, the disclosure of which is incorporated in its entirety herein by reference.

### BACKGROUND

1. Field

The described technology generally relates to a secondary battery.

2. Description of the Related Technology

Batteries are widely used for mobile devices as sources of power. Secondary batteries can be reversibly charged and discharged multiple times. Secondary batteries can also be recycled, and thus may be used efficiently. Also, secondary batteries may have various shapes depending on the external electronic devices employing the secondary batteries. Since secondary batteries can effectively store energy considering their volume and mass, secondary batteries are widely used as sources of power for mobile electronic devices.

Due to the development of mobile communication devices, the need for secondary batteries employed in these communication devices is increasing. Accordingly, research on improving the reliability of secondary batteries such as life characteristics, etc. is being conducted.

The above information is designed to assist in understanding the disclosed technology and therefore it may contain information that does not constitute prior art.

### SUMMARY

One inventive aspect is a secondary battery which may have an improved reliability.

Another aspect is a method of manufacturing a secondary battery including: assembling a secondary battery by storing an electrode assembly in a battery case with an electrolyte including lithium salt, the electrode assembly consisting of a first pole plate, a second pole plate and a separator between the first pole plate and the second pole plate; precharging the secondary battery; storing the precharged secondary battery at room temperature; and performing a first charging and a first discharging of the secondary battery multiple times.

The precharging step includes charging with a constant current-constant voltage (CC-CV) to a range of about 3.5V to about 3.8V at about 0.2 C to about 1.0 C. Here, 1.0 C refers to charging with a current such as the rated power of the secondary battery.

The ceiling voltage of the positive active material may be about 4.2V.

The first charging step may include charging with a CC-CV to a range of about 3.5V to about 3.8V at about 0.2 C to about 1.0 C. Here, 1.0 C refers to charging with a current such as the rated power of the secondary battery.

Also, the first charging step may include charging with a CC-CV up to the range of about SOC 10% to about SOC 30% at about 0.2 C to about 1.0 C.

In the first discharging step, the secondary battery may be discharged with a constant current (CC) to the range of about 2.6V to about 2.8V at about 0.5 C. Here, 1.0 C refers to discharging with a current such as the rated power of the secondary battery.

The first charging and a first discharging may each be performed three times or more. Also, the first charging and the first discharging may each be performed three times to five times.

The first charging may be performed to a SOC in the range of about 20% to about 30%. The first charging and a first discharging may be performed three times or more.

Another aspect is a secondary battery including a first pole plate at least partially coated with a first active material over a first substrate; a second pole plate at least partially coated with a second active material over a second substrate; an electrode assembly consisting of a separator between the first pole plate and the second pole plate; an electrolyte including lithium salt; and a battery case storing the electrode assembly and the electrolyte, wherein the lithium salt is chemically bonded to an outermost side of the second pole plate.

An SEI film may be provided on a surface of the second active material of the second pole plate, and the lithium salt may be bonded on an outer side of the SEI film.

The lithium salt may include at least one of LiPF₆, LiBF₄, LiBETI, LiBOB, LiFAP or LiTFSI.

The lithium salt may be LiPF₆.

The SEI film may include reduced LiPF₆ including a P—F bonded specie having a binding energy in the range of about 686 eV to about 688 eV and LiPF₆ including a P—F bonded specie having a binding energy in the range of about 688 eV to about 690 eV.

The first active material may be a positive active material including a lithium compound, and the second active material may be a negative active material including carbon.

### BRIEF DESCRIPTION OF THE DRAWINGS

The accompanying drawings, together with the specification, illustrate exemplary embodiments of the described technology, and, together with the description, serve to explain the principles of the described technology.

FIG. 1 is flow chart illustrating a method of manufacturing a secondary battery according to an embodiment.

FIG. 2a is a schematic diagram illustrating a cross section of a typical negative active material.

FIG. 2b is a schematic diagram illustrating a cross section of a negative active material according to an embodiment.

FIG. 3 is a graph illustrating a value (dQ/dV) which is the derivative of charge and discharge capacity with respect to voltage V against the voltage according to an embodiment.

FIGS. 4a and 4b are SEM pictures of SEI films that are SOC 10% charged at about 0.5 C.

FIGS. 5a and 5b are SEM pictures of SEI films that are SOC 20% charged at about 0.5 C.

FIGS. 6a and 6b are SEM picture of SEI films that are SOC 30% charged at about 0.5 C.

FIG. 7a is an XPS graph illustrating the composition of an SEI film that is charged one time at about 0.5 C.

FIG. 7b is an XPS graph illustrating the composition of an SEI film charged three times at about 0.5 C.

FIG. 8a is an XPS graph illustrating the composition of an SEI film charged one time at about 0.2 C.

FIG. 8b is an XPS graph illustrating the composition of an SEI film charged three times at about 0.2 C.

FIG. 9 is a graph illustrating reduced LiPF₆ from an SEI film charged at about 0.5 C.

FIG. 10 is a graph illustrating reduced LiPF₆ from an SEI film charged at about 0.2 C.

FIG. 11 is a graph illustrating the ratio, in an atomic ratio, of a P—F bonded specie (reduced LiPF₆) having a binding energy of about 686 eV to about 688 eV and a P—F bonded specie (LiPF₆) having a binding energy of about 688 eV to about 690 eV at the SEI film that is charged at about 0.5 C.

FIG. 12 is a graph illustrating the ratio, in an atomic ratio, of a P—F bonded specie (reduced LiPF₆) having a binding energy of about 686 eV to about 688 eV and a P—F bonded specie (LiPF₆) having a binding energy of about 688 eV to about 690 eV at the SEI film that is charged at about 0.2 C.

FIG. 13 is a graph comparing the content of a P—F bonded specie (reduced LiPF₆) having a binding energy of about 686 eV to about 688 eV according to the method of charging a secondary battery to form the SEI film that is charged at about 0.5 C.

FIG. 14 is a graph comparing the content of a P—F bonded specie (LiPF₆) having a binding energy of about 686 eV to about 688 eV according to the method of charging a secondary battery to form the SEI film that is charged at about 0.2 C.

FIG. 15 is a life-chart illustrating the life characteristics of secondary batteries charged at about 0.5 C.

FIG. 16 is a life-chart illustrating the life characteristics of secondary batteries charged at about 0.2 C.

FIG. 17 is a life-chart illustrating the life characteristics of secondary batteries according to an embodiment and a comparative example.

### DETAILED DESCRIPTION

In the following detailed description, only certain exemplary embodiments of the described technology have been shown and described, simply by way of illustration. As those skilled in the art would realize, the described embodiments may be modified in various different ways, all without departing from the spirit or scope of the described technology. Accordingly, the drawings and description are to be regarded as illustrative in nature and not restrictive. In addition, when an element is referred to as being “on” another element, it can be directly on the other element or be indirectly on the other element with one or more intervening elements interposed therebetween. Also, when an element is referred to as being “connected to” another element, it can be directly connected to the other element or be indirectly connected to the other element with one or more intervening elements interposed therebetween. Hereinafter, like reference numerals refer to like elements.

FIG. 1 is flow chart illustrating a method of manufacturing a secondary battery according to an embodiment.

In the embodiment illustrated in FIG. 1, a method of manufacturing a secondary battery may include assembling the secondary battery by receiving an electrode assembly including a first pole plate, a second pole plate and a separator between the first and second pole plates, along with an electrolyte, in a battery case (S1), precharging the secondary battery (S2), storing the secondary battery at room temperature (S3) and performing first charging and first discharging of the secondary battery (S4).

In the assembling of the secondary battery (S1), the secondary battery may include the first and second pole plates having different polarities and the separator may be configured to prevent shorting from occurring between the first and second pole plates due to direct contact between the first and second pole plates. The first pole plate may be formed by coating a first active material on a metal substrate. The first active material may be a positive active material, and the positive active material may be a lithium compound including lithium cobalt oxide LiCoO2. The second pole plate may be formed by coating a second active material on a metal substrate. The second active material may be a negative active material, and the negative active material may include carbon, etc. The separator may be an electrically insulative thin film having high ion permeability and mechanical strength. The separator may include a porous film, felt, etc. including polyethylene, polypropylene or poly vinylindene fluoride.

The secondary battery may be manufactured by receiving the electrode assembly and the electrolyte in the battery case with the battery case being sealed. The first and second pole plates and the separator may be wound or stacked to form the electrode assembly. The electrolyte may enable ion (such as lithium ions, etc.) mobility. The electrolyte may further include lithium salt or an additive that acts as a supply source of lithium ions in the secondary battery. The electrolyte may be a nonaqueous organic solvent, and the nonaqueous organic solvent may be at least one solvent selected from the group of a linear ester and a ring-shaped ester. The linear ester may be at least one linear ester selected from the group of dimethyl carbonate, ethyl methyl carbonate, diethyl carbonate, dipropyl carbonate, dibutyl carbonate, methyl acetate, ethyl acetate, methyl hexanoate, and methyl formate or any combination thereof. In addition, the ring-shaped ester may be selected from the group of ethylene carbonate, propylene carbonate, butylene carbonate, γbutyrolactone, γ-valerolactone, γ-carprolactone, δ-valerolactone and ε-carprolactone. The lithium salt in the electrolyte may include at least one lithium salt selected of LiPF₆, LiBF₄, LiBETI, LiBOB, LiFAP and LiTFSI. The additive may be added to improve the reliability or safety, etc. of the secondary battery.

The precharging of the secondary battery (S2) may be performed after the assembly of the secondary battery (S1). Precharging may be the first step in charging the assembled secondary battery, and a solid electrode interface (SEI) film may be formed for the first time on the surface of the second pole plate. The SEI film may prevent copper dissolution from the metal plate of the second pole plate, which may be, for example, a metal substrate formed of copper. The precharging may CC-CV charge the secondary battery to a voltage of about 3.5V to 3.8V at a current of about 0.2 C to 1.0 C. Here, 1.0 C refers to charging with the same current as the rated power of the secondary battery. For example, in the case the rated power of the secondary battery is 200 mAh, 1.0 C refers to 200 mA, and 0.2 C refers to 40 mA. That is, in the case the secondary battery is rated at 200mAh, the precharging may be performed by applying a charging current in the range of about 40 mA to about 200 mA. However, the SEI film that is formed in the precharging step (S2) is not completely formed. While the incomplete SEI may not be able to perform all of the substantive functions of a complete SEI film which will be described later, the incomplete SEI film prevents metal from flowing out into the electrolyte from the metal substrate of the second pole plate.

After precharging is completed in the secondary battery, the secondary battery may go through the step of being stored at room temperature (S3). In the step of storing the secondary battery at room temperature (S3), the secondary battery may be left for a predetermined time at room temperature. The electrolyte in the secondary battery may be absorbed by and disposed on the first and second pole plates, allowing lithium ions to move effectively. Also, defects in the secondary battery, such as a tear fluid of the electrolyte or a thickness defect due to a swelling phenomenon, etc., may be sorted out during the predetermined storage time.

The secondary battery that has been stored at room temperature may go through a first charge and a first discharge step (S4). In this step, the secondary battery that has been stored at room temperature may be first charged and first discharged multiple times. The first charge may include CC-CV charging to a voltage of about 3.5V to 3.8V with a current of about 0.2 C to 1.0 C, and the first discharge may include CC discharging to a voltage about 2.6V to 2.8V at a current of about 0.5 C. 1.0 C refers to charging with a current such as the rated power of the secondary battery.

The SEI film may be formed as the negative active material of the second pole plate and the electrolyte react. The precharging step (S2) may be terminated before the negative active material having a complex structure and the electrolyte including a plurality of lithium salts or additives are sufficiently absorbed in the negative active material. As a result, the SEI film formed in the precharging step (S2) may not be completely formed. As such, the incompletely formed SEI film may have a negative impact on the characteristics of the secondary battery and may cause problems to the secondary battery life, capacity, reliability, and safety due to overcharging, etc. Accordingly, since the incomplete formation of the SEI film may be prevented by the steps of storing the secondary battery at room temperature (S3) and first charging and first discharging after the electrolyte is sufficiently absorbed in the negative active material of the second pole plate (S4), performance of the secondary battery may be improved.

Generally, after leaving or storing the secondary battery at room temperature, a formation process is performed in which the SEI film is additionally formed by fully charging up to the ceiling voltage, for example, about 4.2V, of the positive active material, at about 1 C. The second pole plate of the secondary battery may be formed structurally adjacent to the first pole plate and the separator, and the negative active material of the second pole plate may include a conductive agent and a binder, formed to have a complex and random network structure. Therefore, it may be difficult to form a substantially uniform SEI film on the surface of the second pole plate with only a single charge for the negative active material to react with the electrolyte. In addition, it may take a long time to charge the secondary battery up to about 4.2V, which reduces the productivity of the manufacturing of the secondary battery.

In a method of manufacturing a secondary battery according to an embodiment, the SEI film of the secondary battery may be formed by going through the first charge and first discharge step after the step of storing the secondary battery at room temperature. By performing the step of the first charge and first discharge multiple times, the SEI film of the secondary battery may be made substantially uniform. In addition, if the first charge is performed up to about 3.5V to about 3.8V and is CC-CV charged at about 0.2 C to 1.0 C, the charging time of the secondary battery may be reduced. Furthermore, the first discharge may be performed to about 2.6V to about 2.8V and may be CC discharged at about 0.5 C. The first charge and the first discharge may be each performed three times or more, and the first charge and the first discharge may be each performed three times to five times. In the case that the first charge and the first discharge are performed fewer than three times, the SEI film may not be made substantially uniform, which reduces the performance of the secondary battery. Accordingly, the first charge and the first discharge may be performed three times or more. However, since the SEI film may not go through a great change after only the first charge and the first discharge an unnecessary film deterioration may occur in extreme cases, thus the first charge and the first discharge may be performed between three and five times, in consideration of the performance and productivity of the secondary battery.

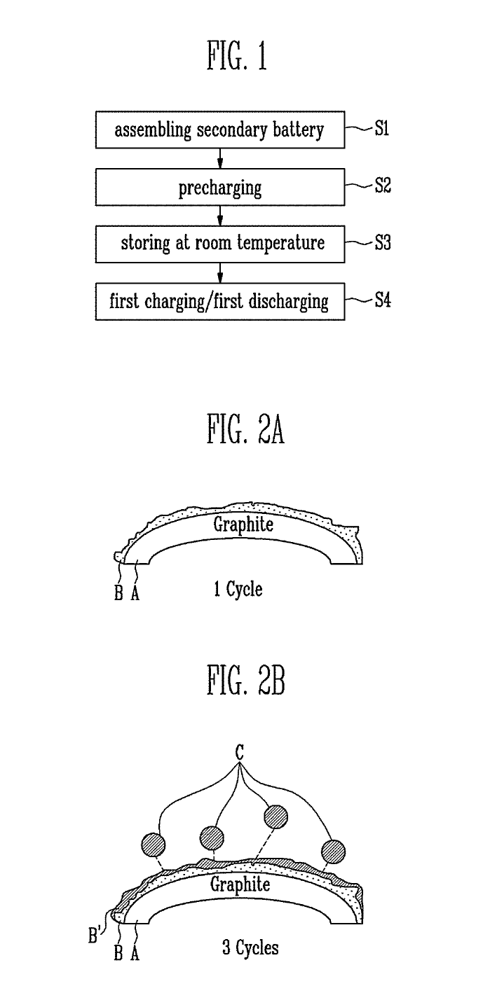

FIG. 2 is a schematic diagram illustrating a cross section of a typical negative active material. FIG. 2b is a schematic diagram illustrating a cross section of a negative active material according to an embodiment. FIG. 3 is a graph illustrating a value (dQ/dV) which is the derivative of charge and discharge capacity with respect to voltage V against the voltage according to an embodiment.

The secondary battery according to an embodiment may include an electrode assembly including a first pole plate coated with a first active material at least partially on a first substrate, a second pole plate coated with a second active material at least partially on a second substrate and a separator between the first and second pole plates; an electrolyte including lithium salt; and a battery case may be configured to receive the electrode assembly and the electrolyte, wherein at an outermost surface of the second pole plate may include the lithium salt chemically bonded thereto. In addition, an SEI film is provided on a surface of the second active material of the second pole plate, and the lithium salt may be bonded to an outer surface of the SEI film.

The first pole plate may be a positive plate, the first substrate may be a metal substrate acting as a positive current collector, and the first active material may be a positive active material. In addition, the second pole plate may be a negative plate, the second substrate may be a metal substrate acting as a negative current collector, and the second active material may be a negative active material.

FIGS. 2a and 2b are schematic diagrams illustrating, using the same secondary battery, the surface A of the negative active material that has been fully charged using a different charging method after the secondary battery has been stored or left at room temperature. FIG. 2a illustrates a cross section of a typical negative active material including an SEI film of a secondary battery that has been charged one time up to about 4.2V and discharged one time at about 0.5 C using a CC-CV method. FIG. 2b illustrates a cross section of a negative active material including a modified film according to an embodiment of a secondary battery that has been charged three times and discharged three times using a CC-CV method charged up to about 3.5V to about 3.8V at about 0.5 C. Here, the discharging may be performed in substantially the same manner as the CC method to about 2.6V to about 2.8V at about 0.5 C. In the case that the secondary battery is only charged one time up to about 4.2V, only the SEI film B is formed on the surface of the negative active material A (FIG. 2a), and in the case that the secondary battery is charged three times up to about 3.5V to about 3.8V (3 cycles), the SEI film B is formed on the surface of the negative active material A. The lithium salt C may be additionally chemically bonded or produced on the outer surface of the SEI film B. The SEI film B in FIGS. 2a and 2b may include RO—CO2Li (alkyl lithium carbonates), (—CH2 CH2O—)n, Li2O, Li2 CO3, LiOH, LiPxFyOz, PxOy or PxFyOz. The modified portion B′ of the outermost surface of the SEI film in FIG. 2b may include a material having a P—F bond strength lower than the P—F bond strength of LiPF₆. Like LiPxFyOz, the modified portion B′ may have a complex structure of P, F, O and C such as WCA or PA77. Here, x, y and z are natural numbers.

Furthermore, the outermost surface of the SEI film B that has been charged three times up to about 3.5V to about 3.8V may be modified (B′). In the case that the lithium salt C is LiPF₆, the lithium salt C may exist as Li+ and PF6− ions in the electrolyte, and the Li+ and PF6− ions may be provided on the surface of the SEI film B due to a chemical bond therebetween. The bond strength between P—F for Li+ and PF6− ions on the surface of the SEI film B is used in binding some of the ions to the SEI film. Therefore, the bond strength may have a binding energy weaker than the bond strength between P—F of Li+ and PF6− ions that are not bonded to the SEI film. Here, in order to distinguish the bonded lithium salt over ordinary lithium salt, the lithium salt that is chemically bonded to the SEI film B is referred to as reduced lithium salt. For example, generally, LiPF₆ (normal) is referred to as LiPF₆, but when it is bonded to the SEI film, it is referred to as reduced LiPF₆.

The SEI film may be a nonconductor. After it is formed, the SEI film may act to prevent a side reaction between lithium ions and other material at the surface of the negative active material when being charged. The SEI film may act as a type of an ion tunnel and may selectively allow only lithium ions to pass. Accordingly, a reaction due to contact between an organic solvent having a great molecule weight which is a type of electrolyte that aids in lithium ion mobility and the negative active material may be prevented, and therefore, destruction of the structure of the negative active material may be avoided. That is, the SEI film may prevent a side reaction between the negative active material and materials other than lithium ions at the surface of the negative active material, and thus the effectiveness of lithium ions may be enhanced. Also, since the structure of the negative active material formed of carbon, etc. may be substantially maintained, the life of the secondary battery may be increased by effectively reversibly charging and discharging the secondary battery. By modifying the SEI film in this way, uniformity and physical properties of the SEI film may be improved.

Referring to FIG. 3, which is a graph illustrating the value (dQ/dV) which is the derivative of charge and discharge capacity with respect to voltage V against the voltage according to an embodiment, the conditions under which the SEI film is formed may be determined. It may be determined that under the conditions of the section up to about the 2.5V in the graph of FIG. 3 an incomplete SEI film is formed as the electrolyte is absorbed by the surface of the negative active material. Under the conditions of the section after about 2.5V, from about 2.7V to about 3.4V a substantial SEI film may be formed. Accordingly, the section of the graph where the secondary battery is charged to about 3.5V or greater is irrelevant to the formation of an SEI film on the negative active material. Consequently, since charging the secondary battery up to about 4.2V unnecessarily increases the charging time thereof, productivity of the manufacturing of the secondary battery is reduced and production cost is increased. Therefore, the charging of the secondary battery for forming the SEI film may be ideally performed up to about 3.4V, but considering the margin of error of equipment, facilities or processes and the types of the electrolytes used, the charging for forming the SEI film may be performed up to about 3.5V to about 3.8V.

As previously described, only charging the secondary battery one time in order to form the SEI film may result in an incomplete formation of an SEI film due to the structural characteristics of the secondary battery, for example, the structure of the negative active material and the complex structure of the electrolyte. Therefore, in the charging for forming the SEI film, the secondary battery may be repeatedly charged up to about 3.5V to about 3.8V three times or more, thereby improving the uniformity of the SEI film, and by modifying the outermost side of the SEI film, the performance of the secondary battery may be improved.

The charged voltage of the secondary battery may be expressed as a state of charge (SOC) which is the remaining capacity, i.e. the charge state of the secondary battery. In the case that the secondary battery is charged with substantially the same voltage as the ceiling voltage of the positive active material, it may be referred to as SOC 100% of the secondary battery. For instance, in a secondary battery where a lithium compound is used as the positive active material, the ceiling voltage may be about 4.2V. Here, when the secondary battery is charged to about 4.2V, the SOC of the secondary battery is 100%. Furthermore, SOC 0% may mean the lowest voltage from the range of voltages actually used in the secondary battery. In the case that the secondary battery is discharged down to about 2.75V, the voltage of the secondary battery may be restored to a voltage higher than about 2.75V due to a spring back phenomenon. As such, the voltage of the secondary battery, after restoration of the voltage due to the spring back phenomenon immediately after the discharge by a charge and discharge system, is SOC 0%. As such, there are differences in the characteristics of some of the secondary batteries with respect to a voltage of SOC 0%. For example, in a secondary battery that uses a lithium compound as the positive active material and has a ceiling voltage of about 4.2V, the voltage values of the secondary battery for SOC 10%, SOC 20% and SOC 30% may be about 3.5V, about 3.7V and about 3.8V, respectively. Accordingly, the first charge may be CC-CV charged to the range of about SOC 10% to SOC 30% with a current in the range of about 0.2 C to about 1.0 C.

In the present disclosure, the terms “Example,” and “Comparative Example” are used arbitrarily to simply identify a particular example or experimentation and should not be interpreted as admission of prior art. While this disclosure has been described in connection with what is presently considered to be practical exemplary embodiments, it is to be understood that the present embodiments is not limited to the disclosed embodiments, but, on the contrary, is intended to cover various modifications and equivalent arrangements included within the spirit and scope of the appended claims. The comparative example will be compared with the embodiments of the described technology in each of the following sections.

1. Assembling, precharging and leaving or storing the secondary battery at room temperature.

The positive plate was manufactured by making the positive active material including the lithium compound in a slurry state and coating the slurry on the metal substrate including an aluminum (Al) sheet. The negative plate was manufactured by making the negative active material including carbon in a slurry state and coating the slurry on the metal substrate including a copper (Cu) sheet. The electrode assembly was manufactured by interposing the separator between the positive plate and the negative plate and winding it. The manufactured electrode assembly was put in the battery case, the electrolyte and the lithium salt were injected and the battery case was sealed. Here, a mixture of ethylene carbonate (EC), ethylene propylene (EP) and diethyl carbonate (DEC) at a volume ratio of 3:5:2 was used as the electrolyte, and 1.0M of LiPF₆ of lithium salt was used.

Using a charge and discharge regulator, the secondary battery was charged up to about 3.5V at about 0.5 C using the CC-CV method. Here, 1.0 C is a current that is substantially the same as the rated power of the secondary battery, and the precharging was performed by charging with such a current. The secondary battery for which the precharging was completed was left at room temperature for one day. Hereinafter, the manufacturing process may be performed by performing the first charge and the first discharge and varying the SOC and the number of cycles of first charging and discharging of the secondary battery. The secondary battery according to the comparative example A and embodiments B to M may be manufactured as shown in Table 1. Each of A to M may include a plurality of secondary batteries, and the following experiment was carried out.

TABLE 1

| | | | | Number of |
|---|---|---|---|---|
| | | Charging current | | charges |
| Type | | (C-rate) | SOC (%) | (Cycles) |
| Ref. | A | 1 | 100 | 1 |
| (0.5 C) SOC10-\textcircled{1} | B | 0.5 | 10 | 1 |
| (0.5 C) SOC10-\textcircled{3} | C | 0.5 | 10 | 3 |
| (0.5 C) SOC20-\textcircled{1} | D | 0.5 | 20 | 1 |
| (0.5 C) SOC20-\textcircled{3} | E | 0.5 | 20 | 3 |
| (0.5 C) SOC30-\textcircled{1} | F | 0.5 | 30 | 1 |
| (0.5 C) SOC30-\textcircled{3} | G | 0.5 | 30 | 3 |
| (0.2 C) SOC10-\textcircled{1} | H | 0.2 | 10 | 1 |
| (0.2 C) SOC10-\textcircled{3} | I | 0.2 | 10 | 3 |
| (0.2 C) SOC20-\textcircled{1} | J | 0.2 | 20 | 1 |
| (0.2 C) SOC20-\textcircled{3} | K | 0.2 | 20 | 3 |
| (0.2 C) SOC30-\textcircled{1} | L | 0.2 | 30 | 1 |
| (0.2 C) SOC30-\textcircled{3} | M | 0.2 | 30 | 3 |

In Table 1 above, A is the comparative example, B to M are the results obtained by performing formation charging and discharging which is the first charge and the first discharge by varying the charging current, the SOC and the number of charge cycles. Table 1 lists the charge current (C-rate), the SOC and the number of cycles (where \textcircled{1} refers to one cycle, and \textcircled{3} refers to three cycles). That is, a different name for B is (0.5 C) SOC10-\textcircled{1}. B is SOC 10% charged, one cycle only, with a 0.5 C charging current.

2. Determination of SEI film surface from repeated SOC and charge and discharge of the secondary battery.

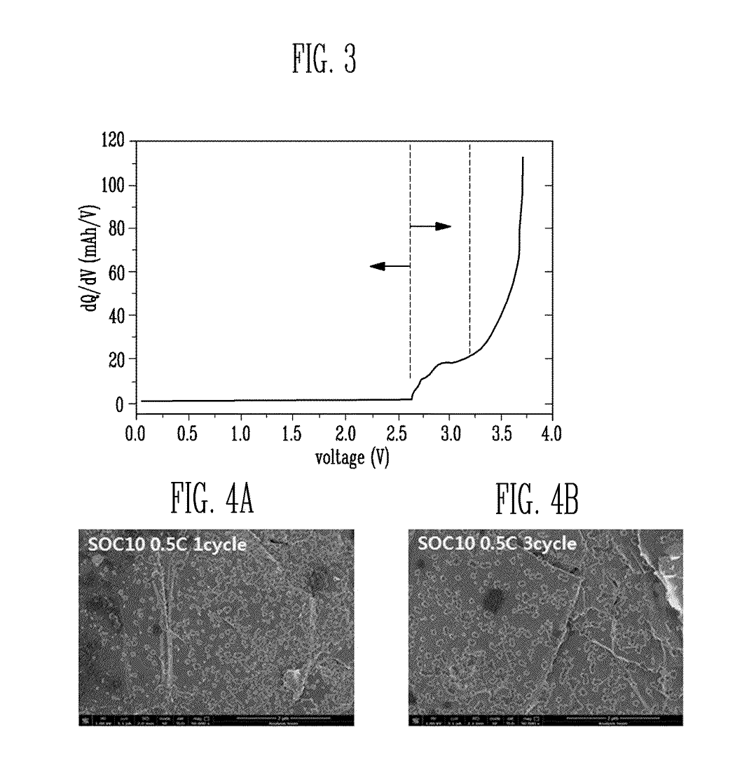

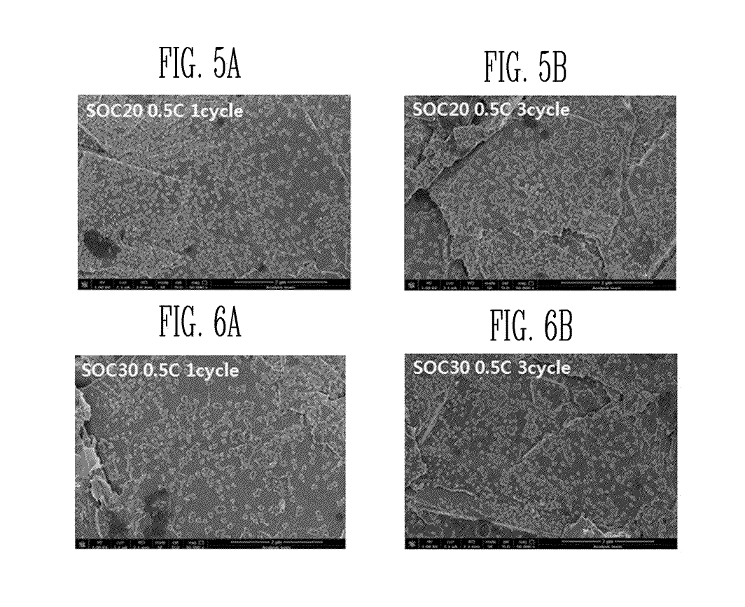

FIGS. 4a and 4b are SEM pictures of SEI films that are SOC 10% charged at about 0.5 C. FIGS. 5a and 5b are SEM pictures of SEI films that are SOC 20% charged at about 0.5 C. FIGS. 6a and 6b are SEM pictures of SEI films that are SOC 30% charged at about 0.5 C.

In FIGS. 4a/b to 6a/b, B to G from Table 1 were used where a one cycle charge and a three cycle charge were performed at SOC 10%, SOC 20% and SOC 30%, respectively at about 0.5 C in order to determine the differences at the surface of the SEI film when the charging and discharging are repeated according to the SOC of the secondary battery. Each of the negative active material surfaces were determined by taking apart the secondary battery of B to G under an argon (Ar) atmosphere. As shown in FIGS. 4a/b to 6a/b, the surfaces of the negative active materials were similar to the extent that it was difficult to distinguish the differences, regardless of the charge density, SOC 10%, SOC 20% and SOC 30%, and the number of charges performed.

3. Determination of the organic matter composition of the SEI film according to repeated SOC and charge and discharge of the secondary battery.

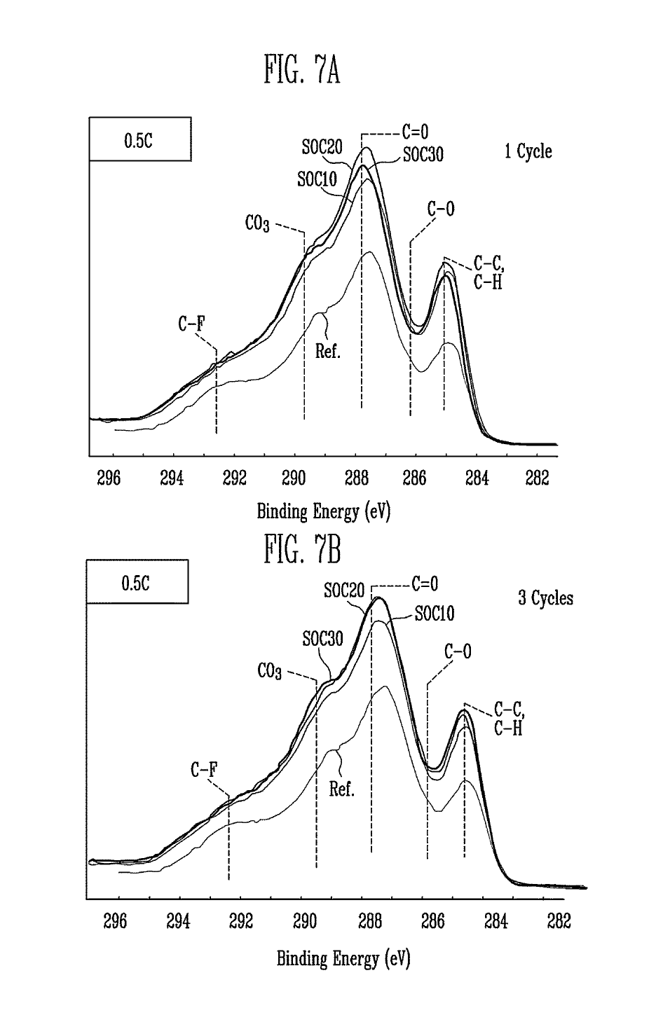

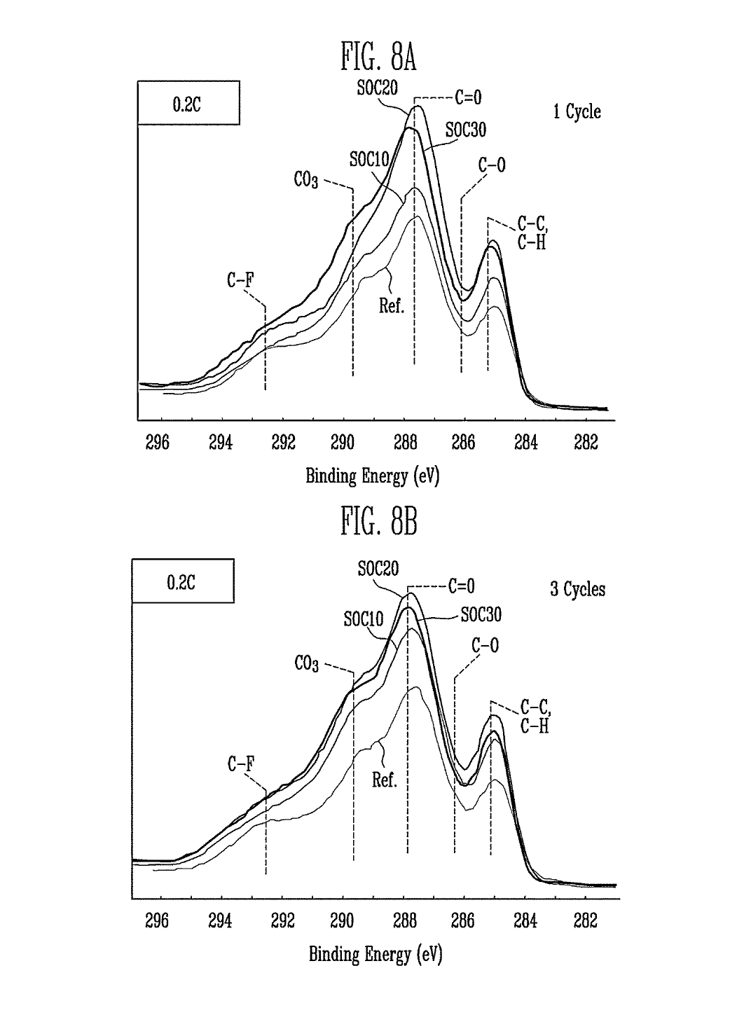

FIG. 7a is an XPS graph illustrating the composition of an SEI film charged one time at about 0.5 C. FIG. 7b is an XPS graph illustrating the composition of an SEI film charged three times at about 0.5 C. FIG. 8a is an XPS graph illustrating the composition of an SEI film charged one time at about 0.2 C. FIG. 8b is an XPS graph illustrating the composition of an SEI film charged three times at about 0.2 C.

FIG. 7a illustrates XPS (C1s, C1s peak) of the SEI film of A, B, D and F in Table 1. FIG. 7b illustrates XPS (C1s, C1s peak) of the SEI film of A, C, E and G in Table 1. A is charged one time up to SOC 100% at about 1 C and shows a lower intensity than B to G which were charged one time and three times per SOC at about 0.5 C. The organic composition relating to the carbon bond of the SEI film of A may be less than B to G. Also, it was determined that there was little difference between one time charge and three time charges at about 0.5 C and between SOC 10%, SOC 20% and SOC 30%. This means that at about 0.5 C, there is little difference in the composition of the SEI film due to charge and discharge repetition (one time or three times) per SOC. That is, when the first charge and the first discharge are performed using a low voltage (or low SOC) of about 0.5 C, it was determined that the SEI film was substantially uniform without a large amount of variation. On the other hand, it was determined that the organic composition relating to the carbon bond in the SEI film increased in B to G which were charged to a low voltage at about 0.5 C (or low SOC) compared to A which was charged to a high voltage (or SOC 100%) at about 1 C.

FIG. 8a illustrates the XPS (C1s, C1s peak) of the SEI film of A and H, J and L in Table 1, and FIG. 8b illustrates the XPS (C1s, C1s peak) of the SEI film of A and I, K and M in Table 1. Referring to FIG. 8a, it was determined that the organic composition relating to the carbon bond of the SEI film of A was the lowest. While in the case of a one time charge at about 0.2 C, the organic composition relating to the carbon bond of the SEI film of J which is SOC 20% and L which is SOC 30% were similar to each other, J and L were higher when compared to H which is SOC 10%. Furthermore, referring to FIG. 8b, the organic composition relating to the carbon bond of the SEI film was the lowest in A and was similar in I, K and M. That is, in the case of charging to a low voltage at about 0.2 C in which the charging current is low (or low SOC), the organic composition relating to the carbon bond in the SEI film was increased compared to when the charge was SOC 100% at about 1 C in A. On the contrary, in the case the secondary battery was charged one time at about 0.2 C, to SOC 10% an SEI film which was lower than in the case of SOC 20% and SOC 30% was produced. When the charge cycle is increased from one cycle to three cycles, similar SEI films were provided regardless of the SOC density. That is, the differences in the SEI film composition that may occur due to a low current and a low charge density may be offset by a repetition of charge cycles.

4. Determination of reduced LiPF₆ of the SEI film according to repeated SOC and charge and discharge of the secondary battery.

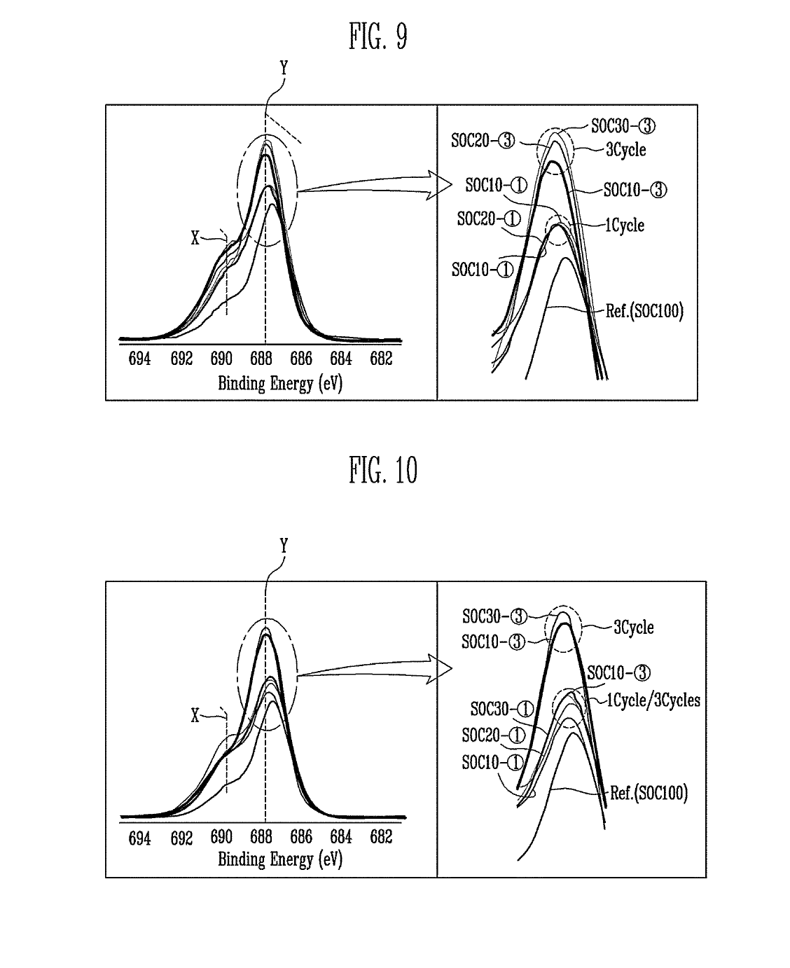

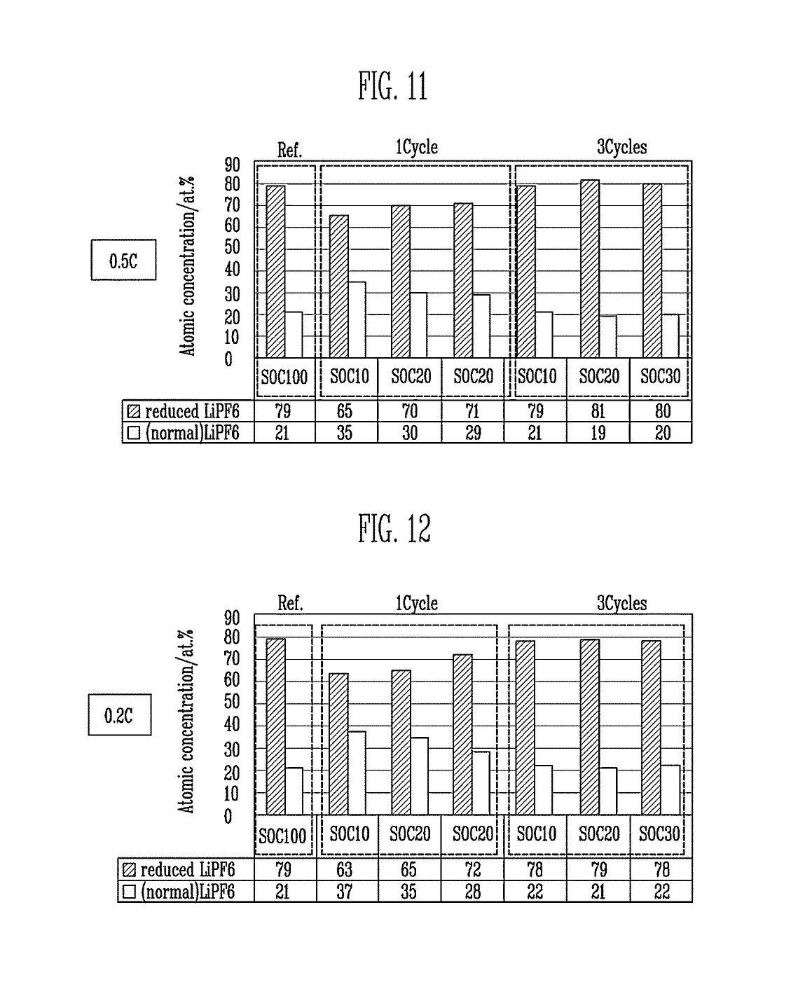

FIG. 9 is a graph illustrating reduced LiPF₆ from an SEI film charged at about 0.5 C. FIG. 10 is a graph illustrating reduced LiPF₆ from an SEI film charged at about 0.2 C. FIGS. 9 and 10 illustrate the binding energy of the P—F bonded specie of normal LiPF₆ and the binding energy of the P—F bonded specie of the reduced LiPF₆. The binding energy of the P—F bonded specie of the normal LiPF₆ was about 688 eV to about 690 eV, while the binding energy of the P—F bonded specie of the reduced LiPF₆ was about 686 eV to about 688 eV. The binding energy of the P—F bonded specie of the reduced LiPF₆ was lower than the binding energy of the P—F bonded specie of the normal LiPF₆.

Referring to FIG. 9, it was determined that A which was one time charged up to SOC 100% at about 1 C had a lower content of LiPF₆ and reduced LiPF₆ than B to G which were charged to SOC 10%, 20% and 30% at about 0.5 C. Also, it was determined that when charged to SOC 10%, 20% and 30% at about 0.5 C with the same number of charge cycles, reduced LiPF₆ existed in similar amounts. Further, when B, D and F which were SOC 10%, 20% and 30% charged one time at about 0.5 C and C, E and G which were SOC 10%, 20% and 30% charged three times at about 0.5 C were compared, it was determined that C, E and G which were three times charged had more reduced LiPF₆. At a low voltage that is SOC 10%, 20% and 30% charged at about 0.5 C, there was more reduced LiPF₆ at the SEI film when charged three times than when charged one time.

Referring to FIG. 10, A which was charged one time up to SOC 100% at about 1 C had lower LiPF₆ and reduced LiPF₆ than H to M which were charged to SOC 10%, 20% and 30% at about 0.2 C. When charged at about 0.2 C, K and M which were repeatedly SOC 20% and 30% charged three times had more reduced LiPF₆ than H, J and L that were SOC 10%, 20% and 30% charged one time. On the contrary, I which was SOC 10% charged three times showed a tendency that was different from K and M. That is, I which was SOC 10% charged three times at about 0.2 C had reduced LiPF₆ similar to H, J and L which were SOC 10%, 20% and 30% charged one time unlike K and M that were repeatedly SOC 20% and 30% charged three times. Since I was charged with a low charge density, there was not enough current for film dissolution or lithium bonding; it was determined that reduced LiPF₆ did not increase even though I, which was SOC 10% charged at about 0.2 C, was repeatedly charged. Also, as will be described later in connection with examination of the secondary battery life, B to M where reduced LiPF₆ is additionally formed had improved life characteristics, in general, when compared to A which was SOC 100% charged at about 1 C. Also, B to M were more strengthened in terms of organic composition in the SEI film when compared to A.

5. Content analysis of (normal) LiPF₆ and reduced LiPF₆ in the SEI film of the secondary battery.

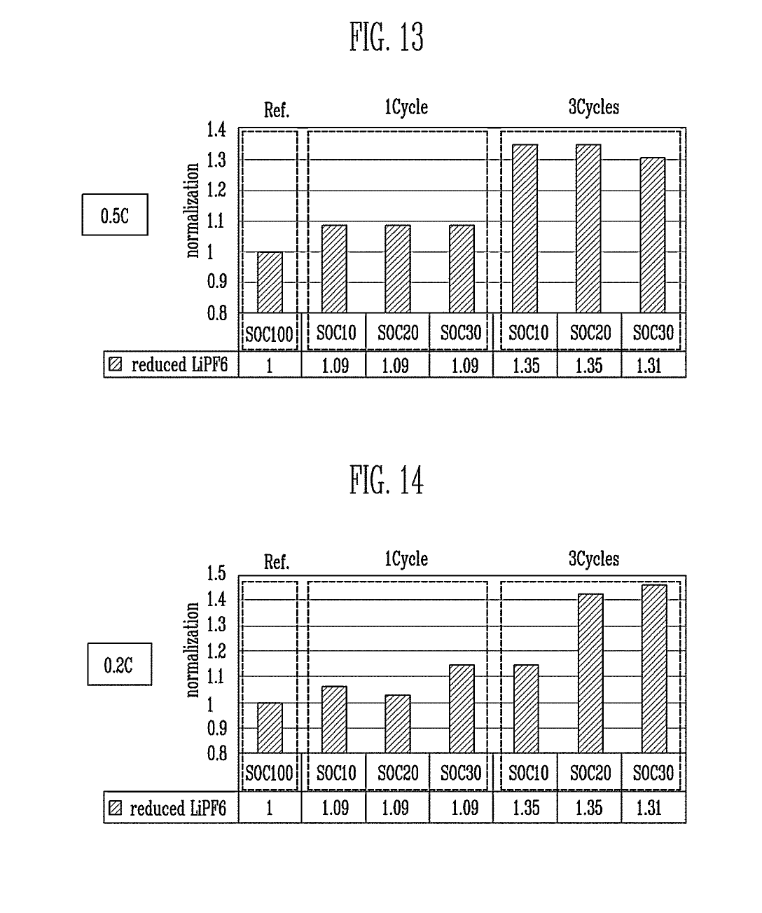

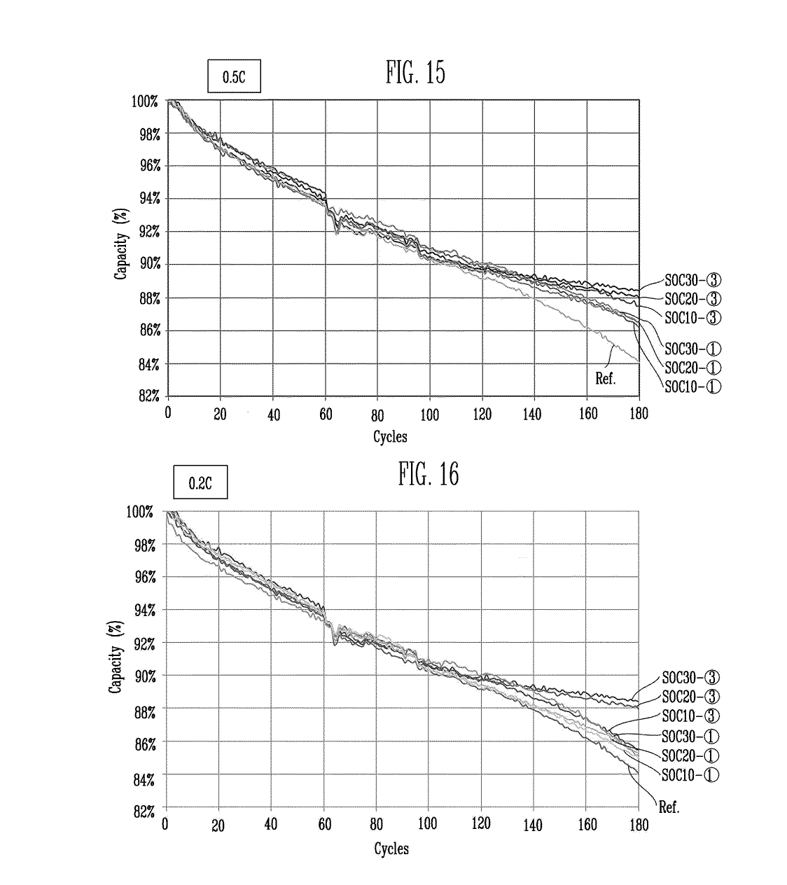

FIG. 11 is a graph illustrating the ratio, in an atomic ratio, of a P—F bonded specie (reduced LiPF₆) having a binding energy of about 686 eV to about 688 eV and a P—F bonded specie (LiPF₆) having a binding energy of about 688 eV to about 690 eV in the SEI film which was charged at about 0.5 C. FIG. 12 is a graph illustrating the ratio, in an atomic ratio, of a P—F bonded specie (reduced LiPF₆) having a binding energy of about 686 eV to about 688 eV and a P—F bonded specie (LiPF₆) having a binding energy of about 688 eV to about 690 eV at the SEI film which was charged at about 0.2 C. FIG. 13 is a graph comparing the content of a P—F bonded specie (reduced LiPF₆) having a binding energy of about 686 eV to about 688 eV according to the method of charging the SEI film which was charged at about 0.5 C. FIG. 14 is a graph comparing the content of a P—F bonded specie (LiPF₆) having a binding energy of about 686 eV to about 688 eV according to the method of charging at the SEI film which was charged at about 0.2 C.

FIGS. 11 and 12 illustrate (normal) LiPF₆ and reduced LiPF₆ contents in an atomic ratio included in the SEI film from A to M in Table 1. Referring to FIGS. 11 and 12, C, E and G and I, K and M which were charged three times at about 0.5 C and at about 0.2 C, respectively, had a different ratio of reduced LiPF₆: (normal) LiPF₆ from B, D and F and H, J and L which were charged one time at about 0.5 C and at about 0.2 C, respectively. That is, while C, E and G and I, K and M had a ratio of about 8:2, B, D and F and H, J and L had a ratio of about 7:3. That is, in the case that the secondary battery was charged at a low voltage with a charging current of about 0.2 C or about 0.5 C such that the secondary battery had low SOC 10%, 20% and 30%, there was an increase in the ratio of reduced LiPF₆ when charging was performed three times (charge cycles repeated) compared to one time charging. This is because as the secondary battery is repeatedly charged and discharged to a low voltage, the SEI film of the secondary battery is modified, and reduced LiPF₆ may be relatively increased.

On the other hand, in the case of A that is charged to SOC 100% at about 1 C, there was a similar ratio of about 8:2 of reduced LiPF₆: (normal) LiPF₆ as in C, E and G and I, K and M which were repeatedly charged three times. However, A was similar to C, E and G and I, K and M which were repeatedly charged three times at a low voltage only in terms of the ratio of 8:2 of reduced LiPF₆: (normal) LiPF₆. As shown in FIGS. 13 and 14, the intensity representing normalization of the content of reduced LiPF₆ was relatively low.

FIGS. 13 and 14 show a comparison value by normalizing the intensity of reduced LiPF₆ in the SEI film. As shown in the ratios in FIGS. 13 and 14, A which was SOC 100% charged at about 1 C showed the smallest value. As described earlier, A's ratio of reduced LiPF₆: (normal) LiPF₆ was similar to C, E and G and I, K and M which were repeatedly charged three times. However, the content of reduced LiPF₆ was different. Compared to A, C, E and G and I, K and M which were repeatedly charged to a low voltage further increased to about 1.3 times to about 1.4 times the reduced LiPF₆. This suggests that the content of reduced LiPF₆ on the whole increases as the SEI film is modified as a result of repeatedly charging and discharging to a low voltage. Also, it was determined that there is a difference in the ratio aspect in terms of the ratio of reduced LiPF₆: (normal) LiPF₆ which is the inorganic composition at the outermost side of the SEI film and the quantitative aspect which is the content of reduced LiPF₆. That is, the SEI film of A formed using a general method had substantially the same ratio of reduced LiPF₆: (normal) LiPF₆ and had a substantially similar function as the SEI films of the repeatedly charged secondary batteries C, E and G and I, K and M. However, by increasing the content of reduced LiPF₆, the intensity of the SEI film characteristics increase, and as a result, the life characteristic of the secondary battery may be improved.

Referring to FIG. 13, reduced LiPF₆ increased in B, D and F which were formed by being charged one time with a low voltage compared to A, but the reduced LiPF₆ had a smaller value when compared to C, E and G which were formed by being repeatedly charged three times. Also, the content of reduced LiPF₆ charged at about 0.5 C was not affected by SOC 10%, 20% and 30% which is the charge density but was affected by the number of charging cycles.

Referring to FIG. 14, a similar tendency as FIG. 13 is shown. It was determined that more reduced LiPF₆ was contained in the SEI film in H to M which were charged with a low voltage at about 0.2 C when compared to A. Also, K and M which were SOC 20% and 30% charged three times had a greater reduced LiPF₆ intensity when compared to H, J and L which were SOC 10%, 20% and 30% charged one time. On the contrary, I which was SOC 10% charged three times had similar reduced LiPF₆ as H, J and L which were charged once. This is because, as confirmed in FIG. 10 above, in the case of I which was SOC 10% charged at about 0.2 C, the charge density is low, and as a result the current required for SEI film decomposition and a reaction with LiPF₆ is insufficient.

4. Determination of life characteristics according to repeated SOC and charging and discharging of the secondary battery.

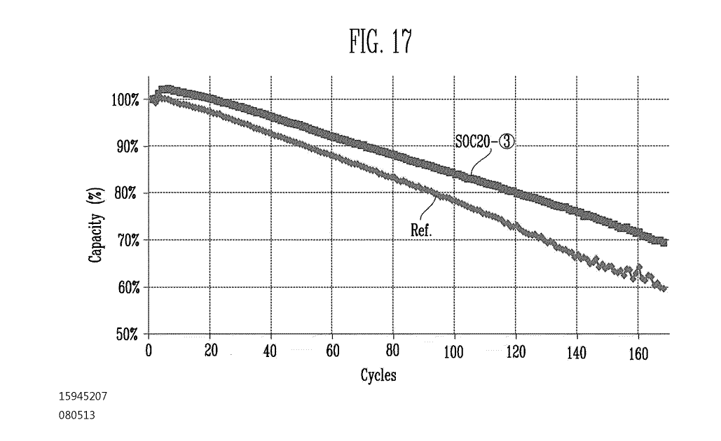

FIG. 15 is a life-chart of secondary batteries charged at about 0.5 C. FIG. 16 is a life-chart of secondary batteries charged at about 0.2 C. In FIGS. 15 and 16, a mixture of EC, EP and DEC at a volume ratio of 3:5:2 was used as the electrolyte, and 1.0M of LiPF₆ of lithium salt was used. The charging and discharging cycles were determined in which A to M were charged up to about 4.2V at about 0.5 C and discharged down to about 3.2V at about 0.5 C, using the secondary battery where the SEI film was formed upon completion of assembling the secondary battery, and the life characteristics of the ratio were determined with respect to the rated power of the secondary battery.

Referring to FIG. 15, B to G which were charged at about 0.5 C had superior life characteristics over A. Also, C, E and G which were charged three times had superior life characteristics compared to B, D and F which were charged one time. Also, referring to FIG. 16, H to M which were charged with a low voltage had improved life characteristics compared to A which was SOC 100% charged at about 1 C. Also, in the case of charging at about 0.2 C, the life characteristic of K and M which were SOC 20% and 30% charged three times were improved over H, J and L which were SOC 10%, 20% and 30% charged one time. However, I which was SOC 10% charged three times was similar to H, J and L. As described earlier, this is a similar tendency as the one found with the SEI film characteristic, and it was determined again that the SEI film affects the life characteristics of the secondary battery.

That is, as described earlier, by performing the first charge and the first discharge three times or more, the SEI film characteristics as well as the life characteristics can be improved. Also, in formation charging, the secondary battery is charged with a low voltage, low SOC, and consequently the time for formation process can be reduced, which improves productivity of the manufacturing.

FIG. 17 is a life-chart of a secondary battery according to an embodiment and a comparative example.

FIG. 17 illustrates the results of the life characteristics using a different electrolyte from FIGS. 15 and 16, and from FIG. 17, it was determined that even when the type of the electrolyte and the concentration of the lithium salt were different, the same results were obtained according to an embodiment. In FIG. 17, a mixture of EC, EMC and DMC at a volume ratio of 2:3:6 was used as the electrolyte, and there was 1.4M of LiPF₆ in the electrolyte. After the leaving or storing of the secondary battery at room temperature, the life characteristics of the secondary battery were much improved in an embodiment where the secondary battery was repeatedly SOC 20% charged three times at about 0.5 C compared to the comparative example A where the first charge (formation charge) involves SOC 100% charging at about 1 C.

By way of summation and review, the secondary battery in various embodiments has improved life characteristics and reliability.

Also, the secondary battery has an improved SEI film.

Furthermore, a formation process used in manufacturing the secondary battery is disclosed.

While the present invention has been described in connection with certain exemplary embodiments, it will be appreciated by those skilled in the art that various modifications and changes may be made without departing from the scope of the present disclosure. It will also be appreciated by those of skill in the art that parts included in one embodiment are interchangeable with other embodiments; one or more parts from a depicted embodiment can be included with other depicted embodiments in any combination. For example, any of the various components described herein and/or depicted in the Figures may be combined, interchanged or excluded from other embodiments. With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. Thus, while the present disclosure has described certain exemplary embodiments, it is to be understood that the invention is not limited to the disclosed embodiments, but, on the contrary, is intended to cover various modifications and equivalent arrangements included within the spirit and scope of the appended claims, and equivalents thereof.

What is claimed is:

1. A method of manufacturing a secondary battery comprising:
assembling the second battery by storing an electrode assembly in a battery case with an electrolyte including a lithium salt, the electrode assembly including a first electrode plate, a second electrode plate and a separator between the first and second electrode plates;
precharging the secondary battery;
storing the secondary battery at room temperature for a predetermined time; and
performing first charging and first discharging of the secondary battery multiple times.

2. The method of claim 1, wherein the first charging comprises charging the secondary battery with a constant current-constant voltage (CC-CV) to the range of about 3.5V to about 3.8V with a current in the range of about 0.2 C to about 1.0 C, wherein the first discharging comprises discharging the secondary battery with a constant current (CC), and wherein C is a rated power of the secondary battery.

3. The method of claim 2, wherein the first charging further comprises charging the secondary battery to the range of about 3.5V to about 3.8V with a current in the range of about 0.2 C to about 0.5 C and wherein the first discharging further comprises discharging the secondary battery to the range of about 2.6V to about 2.8V with a current of about 0.5 C.

4. The method of claim 1, wherein the first charging and the first discharging are each performed three times or more.

5. The method of claim 4, wherein the first charging and the first discharging are each performed between three and five times.

6. The method of claim 1, wherein the first charging comprises charging the secondary battery to a voltage less than a ceiling voltage of the secondary battery.

7. The method of claim 6, wherein the ceiling voltage is about 4.2V.

8. The method of claim 1, wherein the first charging comprises CC-CV charging the secondary battery to a state of charge SOC in the range of about 10% to about 30%.

9. The method of claim 1, wherein the first charging comprises CC-CV charging the secondary battery to a SOC in the range of about 10% to about 30% at a current of about 0.2 C or about 0.5 C.

10. The method of claim 1, wherein the precharging comprises charging the secondary battery to the range of about 3.5V to about 3.8V with a current in the range of about 0.2 C to about 1.0 C, wherein C is a rated power of the secondary battery.

11. A secondary battery comprising:
an electrode assembly including:
a first electrode plate;
a second electrode plate;
a separator between the first and second electrode plates;
an electrolyte including a lithium salt;
a battery case storing the electrode assembly and the electrolyte; and
a solid electrode interface (SEI) film formed over the second electrode plate,
wherein the SEI film is formed by precharging the secondary battery, storing the secondary battery at room temperature, and performing first charging and first discharging of the secondary battery multiple times.

12. The secondary battery of claim 11, wherein the first charging comprises charging the secondary battery with a constant current-constant voltage (CC-CV) to the range of about 3.5V to about 3.8V with a current in the range of about 0.2 C to about 0.5 C and wherein the first discharging comprises discharging the secondary battery with a constant current (CC) to the range of about 2.6V to about 2.8V with a current of about 0.5 C, wherein C is a rated power of the secondary battery.

13. The secondary battery of claim 11, wherein the lithium salt is bonded to an outer surface of the SEI film.

14. The secondary battery of claim 11, wherein the lithium salt comprises at least one of LiPF₆, LiBF₄, LiBETI, LiBOB, LiFAP or LiTFSI.

15. The secondary battery of claim 11, wherein the SEI film comprises LiPF₆ and reduced LiPF₆, wherein the reduced LiPF₆ comprises a P—F bonded specie having a binding energy in the range of about 686 eV to about 688 eV and wherein the LiPF₆ comprises a P—F bonded specie having a binding energy in the range of about 688 eV to about 690 eV.

16. The secondary battery of claim 11, wherein the first electrode plate is at least partially coated with a positive active material including a lithium compound, and wherein the second electrode plate is at least partially coated with a negative active material including carbon.

17. The secondary battery of claim 11, wherein the first charging and the first discharging are each performed three times or more.

18. The secondary battery of claim 17, wherein the first charging and the first discharging are each performed between three and five times.

19. The secondary battery of claim 11, wherein the precharging comprises charging the secondary battery to the range of about 3.5V to about 3.8V with a current in the range of about 0.2 C to about 1.0 C, wherein C is a rated power of the secondary battery.

20. The secondary battery of claim 11, wherein the first charging comprises CC-CV charging the secondary battery to a SOC in the range of about 10% to about 30%.
